(19) United States
(12) Patent Application Publication
(10) Pub. No.: US 2024/0241226 A1
(43) Pub. Date: Jul. 18, 2024

(54) GALVANOMETER MOTOR AND LIDAR

(71) Applicant: Suteng Innovation Technology Co., Ltd., Shenzhen (CN)

(72) Inventor: Congcong Zhu, Shenzhen (CN)

(73) Assignee: Suteng Innovation Technology Co., Ltd., Shenzhen (CN)

(21) Appl. No.: 18/405,029

(22) Filed: Jan. 5, 2024

(30) Foreign Application Priority Data
Jan. 12, 2023 (CN) 202310070960.4

(51) Int. Cl. G01S 7/481; G01B 7/30

(52) U.S. Cl. CPC G01S 7/4817; G01B 7/30

(57) ABSTRACT

The present disclosure relates to the technical field of LiDAR, and provides a galvanometer motor and LiDAR. The galvanometer motor includes a stator assembly and a rotor assembly. The stator assembly includes a housing and a stator winding. The stator winding is mounted inside the housing. The rotor assembly includes a first shaft, a second shaft, a magnetic core, and a lens. The first shaft is rotatably disposed in the housing. The stator winding is connected to an alternating current to generate the alternating magnetic field. The magnetic core is driven by the alternating magnetic field to drive the entire rotor assembly to rotate, thereby rotating the lens. The magnetic core, and the second shaft are connected in sequence, the length of the rotor assembly is shortened, which is beneficial to the miniaturization design of the galvanometer motor and the LiDAR.

### CROSS-REFERENCE TO RELATED APPLICATION

The present application claims the benefit of priority to Chinese Patent Application No. 202310070960.4, filed on Jan. 12, 2023, which is hereby incorporated by reference in its entirety.

### TECHNICAL FIELD

The present disclosure relates to the technical field of LiDAR, and in particular, to a galvanometer motor and a LiDAR.

### BACKGROUND

A LiDAR system requires a polygon mirror motor and a galvanometer motor to drive the polygon mirror and the galvanometer to change in the horizontal and vertical directions respectively, thereby changing the laser beam in the horizontal and vertical directions to achieve two-dimensional scanning. The polygon mirror motor drives the polygon mirror to rotate to complete scanning in the horizontal direction, while the galvanometer motor drives the galvanometer to rotate within a limited angle to complete the scanning of light in the vertical direction. However, existing galvanometer motors are often elongated, and due to the length of the galvanometer motor, it is not conducive to the installation of the LiDAR, which also leads to an increase in the overall volume of the LiDAR, not meeting the requirements for miniaturization of the LiDAR.

### SUMMARY

Embodiments of the present application provide a galvanometer motor and a LiDAR system, to solve the technical problem of excessive length in existing galvanometer motors.

On one aspect, this application provides a galvanometer motor, which includes:
a stator assembly, comprising a housing and a stator winding, with the stator winding installed inside the housing;
a rotor assembly, comprising a first shaft, a second shaft, a magnetic core, and a lens, with the first shaft rotatably disposed in the housing, one end of the first shaft extending out of the housing and fixedly connected to the lens, another end of the first shaft fixedly connected to the second shaft, the magnetic core fixedly sleeved on the first shaft, the stator winding surrounding the magnetic core, and the stator winding generating an alternating magnetic field to drive the magnetic core to rotate.

In an embodiment, the galvanometer motor further includes an electronic control board and an angular position sensor, with the electronic control board mounted in the housing, the angular position sensor configured to detect the angular position of the rotor assembly, and the angular position sensor electrically connected to the electronic control board.

In an embodiment, the electronic control board is mounted at the end of the housing far away from the lens, the angular position sensor includes a magnetic member and a magnetic encoder, the magnetic member is mounted on the second shaft, the magnetic encoder is mounted on the electronic control board, and there is a gap between the magnetic encoder and the magnetic member.

In an embodiment, the magnetic member is mounted on the end of the second shaft close to the electronic control board, the magnetic encoder is mounted on the surface of the electronic control board close to the second shaft, the gap is greater than or equal to 1.2 mm, and the gap is less than or equal to 3 mm.

In an embodiment, the angular position sensor further includes a magnetic mounting member, one end of the magnetic mounting member has a first mounting groove for fixedly sleeving the second shaft, and another end of the magnetic mounting member has a second mounting groove for fixedly sleeving the magnetic member.

In an embodiment, the housing has a limit groove, the limit groove has a first limit wall and a second limit wall that are alternately distributed along the rotation direction of the rotor assembly, the rotor assembly further includes a limit shaft, one end of the limit shaft is mounted on the second shaft, another end of the limit shaft is located in the limit groove, and the limit shaft swings between the first limit wall and the second limit wall with the second shaft.

In an embodiment, the stator winding is a single-phase winding, which includes a first linear segment, a second linear segment, and a connecting segment, the connecting segment connects the first linear segment and the second linear segment, the first linear segment has a wiring end, the housing has a wire outlet groove, the length direction of the wire outlet groove is parallel to the axis of rotation of the first shaft, and the wire outlet groove and the first linear segment are on the same radial direction of the first shaft.

In an embodiment, the outer wall of the end of the housing close to the lens is provided with an avoidance chamfer, so that the outer diameter of the end of the housing close to the lens gradually increases in a direction far away from the lens.

In an embodiment, the galvanometer motor further includes a first bearing and a second bearing alternately mounted in the housing, with the first bearing sleeved on the end of the first shaft far away from the second shaft, and the second bearing sleeved on the second shaft.

In an embodiment, the galvanometer motor further includes an elastic member, one end of the elastic member abuts an end of the second bearing far away from the first bearing, and another end of the elastic member abuts the housing.

In an embodiment, the housing includes an outer cylinder and an end cover, the outer cylinder is used for mounting the stator winding, and the end cover is connected to the outer cylinder at an end far away from the lens.

On a second aspect, this application provides a LiDAR system, which includes the galvanometer motor as described in any one of the aforementioned embodiments.

The beneficial effects of the galvanometer motor and LiDAR system provided by this application are: the stator winding is connected to an alternating current, generating an alternating magnetic field, under which the magnetic core drives the entire rotor assembly to rotate, achieving the rotation of the lens; within the rotor assembly, the magnetic core is sleeved on the first shaft, and the second shaft is fixedly connected to the end of the first shaft, compared to the sequential connection of the first shaft, magnetic core, and second shaft, this is advantageous for shortening the length of the rotor assembly, solving the problem of excessive length in existing galvanometer motors, thereby facilitating the miniaturization design of the galvanometer motor and LiDAR system.

### BRIEF DESCRIPTION OF DRAWINGS

To provide a clearer explanation of the technical solutions in the embodiments of the present application, the following is a brief introduction to the drawings used in the embodiments. It is obvious that the drawings described below are only some embodiments of the present application.

FIG. 1 is a schematic structural diagram of a galvanometer motor provided by an embodiment of the present application;

FIG. 2 is a sectional view of the galvanometer motor according to an embodiment;

FIG. 3 is an exploded view of the galvanometer motor with the elastic member removed according to an embodiment;

FIG. 4 is a schematic structural diagram of the rotor assembly of the galvanometer motor according to an embodiment;

FIG. 5 is an exploded view of the rotor assembly of the galvanometer motor according to an embodiment;

FIG. 6 is a schematic structural diagram of the end cover of the housing of the stator assembly according to an embodiment;

FIG. 7 is another perspective view of the end cover of the housing according to an embodiment;

FIG. 8 is yet another perspective view of the end cover of the housing according to an embodiment;

FIG. 9 is a schematic structural diagram of the outer cylinder of the housing of the stator assembly according to an embodiment;

FIG. 10 is another perspective view of the outer cylinder of the housing of the stator assembly according to an embodiment;

FIG. 11 is a schematic structural diagram of the stator winding of the stator assembly of the galvanometer motor according to an embodiment.

In the figures, the reference numerals indicate:
100: stator assembly;
110: housing;
111: outer cylinder;
1111: annular limit block;
112: end cover;
1121: support plate;
113: limit groove;
1131: first limit wall;
1132: second limit wall;
114: avoidance chamfer;
115: bearing chamber;
116: wire outlet groove;
120: stator winding;
121: first linear segment;
122: second linear segment;
123: connecting segment;
124: wiring end;
200: rotor assembly;
210: first shaft;
211: first protruding ring;
220: second shaft;
221: second protruding ring;
222: limit step;
230: magnetic core;
240: lens;
250: limit shaft;
260: lens clamp;
261: clamping groove;
262: first clamping part;
263: second clamping part;
300: electronic control board;
400: angular position sensor;
410: magnetic member;
420: magnetic encoder;
430: magnetic mounting member;
510: first bearing;
520: second bearing;
530: elastic member.

### DETAILED DESCRIPTION

The detailed description of the embodiments of the present disclosure is provided below. Examples of the embodiments are shown in the accompanying drawings, where the same or similar reference numerals denote the same or similar elements or elements with the same or similar functions throughout. The embodiments described by reference to the drawings are exemplary and intended to explain the disclosure.

Throughout the specification, reference to “an embodiment” or “embodiment” means that a particular feature, structure, or characteristic described in connection with the embodiment is included in at least one embodiment of the application. Thus, the phrases “in an embodiment” or “in some embodiments” appearing throughout the specification do not necessarily all refer to the same embodiment. Furthermore, particular features, structures, or characteristics may be combined in any suitable manner in one or more embodiments.

In the description of the present disclosure, the terms “length,” “width,” “upper,” “lower,” “front,” “rear,” “left,” “right,” “vertical,” “horizontal,” “top,” “bottom,” “inner,” “outer,” etc., indicate orientations or positional relationships based on those shown in the figures, are only for convenience in describing the present disclosure and simplifying the description, and do not indicate or imply that the device or element referred to must have a particular orientation, be constructed and operated in a particular orientation.

Moreover, the terms “first,” “second,” etc., are used for descriptive purposes only and should not be construed as indicating or implying relative importance or implicitly indicating the number of technical features indicated. Thus, features defined with “first,” “second,” etc., may explicitly or implicitly include one or more of such features.

In the present disclosure, unless otherwise expressly specified and defined, terms such as “mounted,” “connected,” “connected,” “fixed,” etc., should be broadly understood, for example, they can be fixedly connected or detachably connected, or integrated; they can be mechanically connected or electrically connected; they can be directly connected or indirectly connected through an intermediate medium, and can be the communication inside two elements or the interaction between two elements.

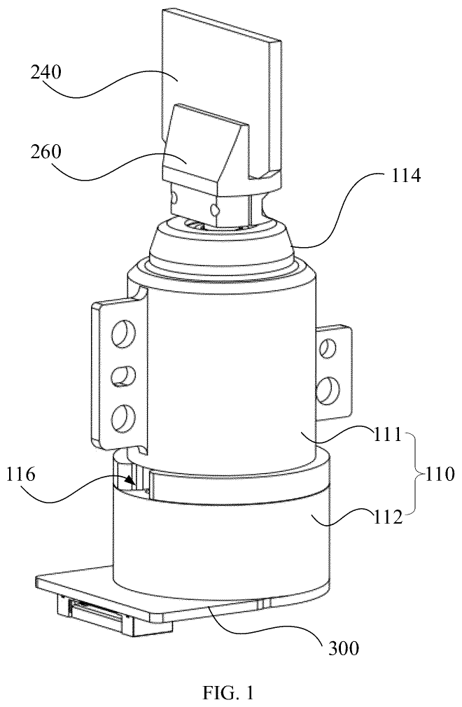

Please refer to FIGS. 1 to 3 for an explanation of the galvanometer motor in the embodiment of the present disclosure.

The galvanometer motor includes a stator assembly 100 and a rotor assembly 200. The stator assembly 100 includes a housing 110 and a stator winding 120, with the stator winding 120 mounted inside the housing 110. The rotor assembly 200 includes a first shaft 210, a second shaft 220, a magnetic core 230, and a lens 240. The first shaft 210 is rotatably disposed in the housing 110, with one end of the first shaft 210 extending out of the housing 110 and fixedly connected to the lens 240, and the other end of the first shaft 210 fixedly connected to the second shaft 220. The magnetic core 230 is fixedly sleeved on the first shaft 210, with the stator winding 120 surrounding the magnetic core 230, and the stator winding 120 generating an alternating magnetic field to drive the rotation of the magnetic core 230.

In an embodiment, the stator winding 120 is connected to an alternating current to generate an alternating magnetic field, and the magnetic core 230 drives the entire rotor assembly 200 to rotate under the action of the alternating magnetic field, achieving the rotation of the lens 240. In the rotor assembly 200, the magnetic core 230 is sleeved on the first shaft 210, and the second shaft 220 is fixedly connected to the end of the first shaft 210. Compared to the sequential connection of the first shaft 210, the magnetic core 230, and the second shaft 220, this is beneficial for shortening the length of the rotor assembly 200, solving the problem of excessive length in existing galvanometer motors, thereby facilitating the miniaturization design of the galvanometer motor and LiDAR.

In an embodiment, the rotor assembly 200 includes separately manufactured first shaft 210 and second shaft 220, avoiding the direct production of an integrally formed first shaft 210 and second shaft 220, reducing the complexity of shaft processing. Additionally, the outer diameter of the end of the second shaft 220 near the first shaft 210 is larger than the outer diameter of the first shaft 210 near the second shaft 220. The two are interconnected, reducing the length-to-diameter ratio of the rotor assembly 200 and optimizing the length-to-diameter ratio of the galvanometer motor. The magnetic core 230 being sleeved on the first shaft 210 also reduces the length-to-diameter ratio of the rotor assembly 200.

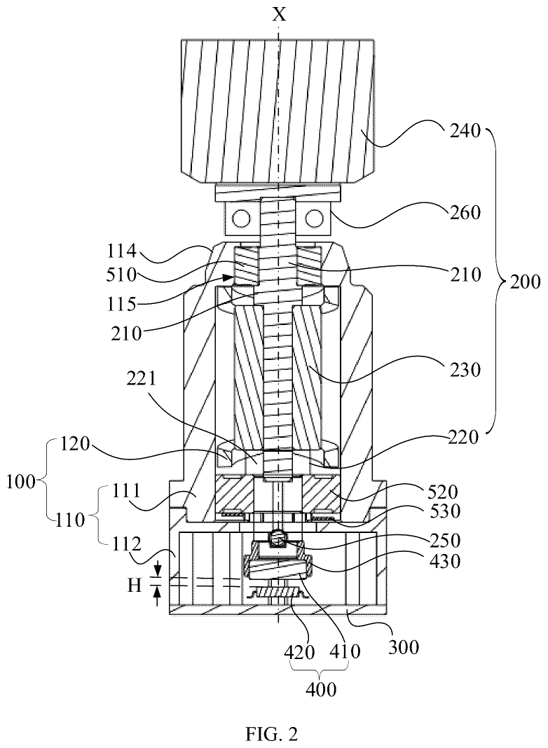

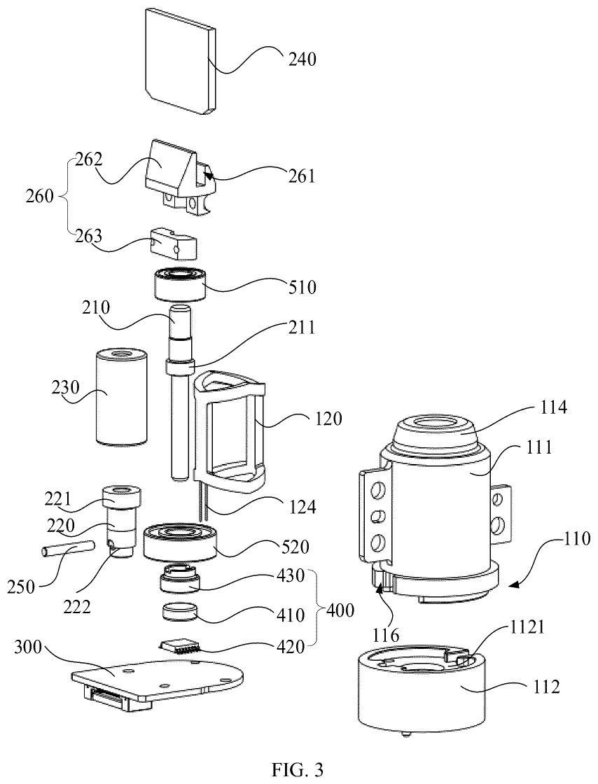

In some embodiments, combined with FIGS. 2 and 3, the galvanometer motor also includes an electronic control board 300 and an angular position sensor 400. The electronic control board 300 is mounted in the housing 110, and the angular position sensor 400 is used to detect the angular position of the rotor assembly 200, with the angular position sensor 400 electrically connected to the electronic control board 300. The electronic control board 300 receives the angular position of the rotor assembly 200 obtained by the angular position sensor 400 and sends it to an external control center. The electronic control board 300 can also be used to receive angle control commands sent by the external control center, controlling the rotation frequency and rotation angle of the rotor assembly 200 by controlling the alternating current of the stator winding 120.

In an embodiment, the electronic control board 300 is electrically connected to the stator winding 120. The electronic control board 300 is used for the power supply and external communication of the galvanometer motor. The wiring end 124 of the stator winding 120 is soldered and fixed to the electronic control board 300.

In an embodiment, the electronic control board 300 is mounted at an end of the housing 110 far away from the lens 240. Specifically, the electronic control board 300 is located outside the housing 110, avoiding occupying the internal cavity of the housing 110, preventing an increase in the volume of the housing 110, and facilitating the connection of the electronic control board 300 with external devices. The electronic control board 300 is detachably mounted at the end of the housing 110 with fasteners.

The angular position sensor 400 can be a magnetic sensor or a photoelectric sensor.

For example, combined with FIG. 2, the angular position sensor 400 includes a magnetic member 410 and a magnetic encoder 420. The magnetic member 410 is mounted on the second shaft 220, and the magnetic encoder 420 is mounted on the electronic control board 300, with a gap H between the magnetic encoder 420 and the magnetic member 410. The magnetic member 410 rotates synchronously with the second shaft 220 and the rotor assembly 200, while the magnetic encoder 420 is fixedly mounted on the electronic control board 300 and is relatively stationary with respect to the housing 110. The magnetic member 410 rotates relative to the magnetic encoder 420, and as the magnetic member 410 rotates, the magnetic field signal sensed by the magnetic encoder 420 changes accordingly. The magnetic encoder 420 obtains the rotation information of the rotor assembly 200 relative to the housing 110 by sensing the magnetic field signal of the magnetic member 410.

The magnetic encoder 420 can be selected from Hall sensors, Magneto Resistance (MR) sensors, or Magneto Impedance (MI) sensors. The magnetic member 410 can be selected as a magnet.

In some embodiments, the angular position sensor 400 does not include the magnetic member 410. In this case, the magnetic encoder 420 obtains the rotation information of the rotor assembly 200 relative to the housing 110 by sensing the magnetic field signal of the magnetic core 230.

In an embodiment, combined with FIGS. 2 and 3, the magnetic member 410 is mounted on the end of the second shaft 220 close to the electronic control board 300, and the magnetic encoder 420 is mounted on the surface of the electronic control board 300 close to the second shaft 220. This shortens the gap between the magnetic member 410 and the magnetic encoder 420, and with the two being relatively arranged without any device blocking, it is beneficial for improving the accuracy of the magnetic encoder 420 in sensing the magnetic field signal of the magnetic member 410, enhancing the accuracy of angle measurement.

In an embodiment, the gap H is greater than or equal to 1.2 mm and less than or equal to 3 mm. By testing and adjusting the distance between the magnetic member 410 and the magnetic encoder 420, the magnetic encoder 420 is placed in a magnetic induction intensity range of 80 mT-120 mT, where the measurement performance of the magnetic encoder 420 is optimal.

In an embodiment, the maximum value of the gap His 1.6 mm to 1.8 mm, which on one hand satisfies the magnetic induction intensity range of 80 mT-120 mT, and on the other hand avoids the overall length of the galvanometer motor being too long due to an excessively large gap H.

In an embodiment, combined with FIG. 2, the angular position sensor 400 also includes a magnetic mounting member 430. One end of the magnetic mounting member 430 has a first mounting groove for fixedly sleeving the second shaft 220, and the other end of the magnetic mounting member 430 has a second mounting groove for fixedly sleeving the magnetic member 410. The magnetic mounting member 430 sleeves the end of the second shaft 220 with the first mounting groove, achieving precise positioning and installation without the need for other auxiliary installation tools such as screws, avoiding an excessive increase in the outer diameter of the end of the rotor assembly 200. Similarly, the magnetic member 410 is fixedly sleeved in the magnetic mounting member 430 through the second mounting groove, achieving precise positioning and installation of the magnetic member 410 without the need for other auxiliary installation tools.

In an embodiment, the magnetic mounting member 430 is fixed to the end of the second shaft 220 by adhesive bonding, interference fit, or snap fitting. The magnetic member 410 is fixed in the second mounting groove by adhesive bonding, interference fit, or snap fitting. For example, the magnetic mounting member 430 is sleeved on the second shaft 220 by pressure interference fit, and the magnetic member 410 is fixed in the second mounting groove by dispensing and bonding.

In an embodiment, the second shaft 220 has a limit step 222, and the end face of the magnetic mounting member 430 with the first mounting groove abuts against the limit step 222, achieving positioning in the rotation direction X of the first shaft 210.

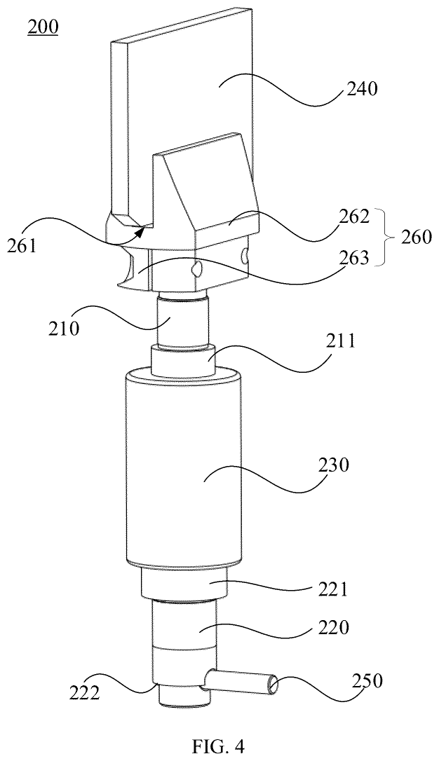

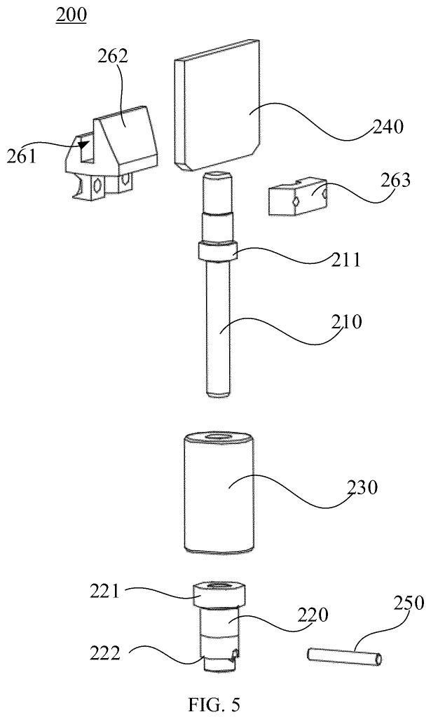

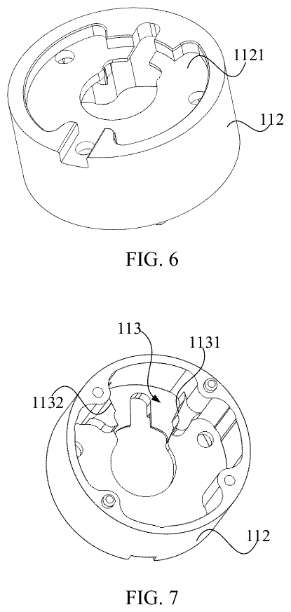

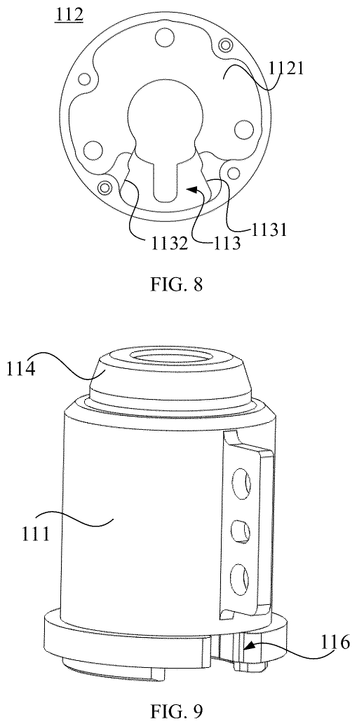

In some embodiments, combined with FIGS. 6 to 8, the housing 110 has a limit groove 113, with the limit groove 113 having a first limit wall 1131 and a second limit wall 1132 alternately distributed along the rotation direction of the rotor assembly 200. Combined with FIGS. 4 and 5, the rotor assembly 200 also includes a limit shaft 250, with one end of the limit shaft 250 mounted on the second shaft 220, and the other end of the limit shaft 250 located in the limit groove 113. The limit shaft 250 swings between the first limit wall 1131 and the second limit wall 1132 with the second shaft 220. The limit groove 113 is used to limit the swing angle of the rotor assembly 200, meeting the small angle requirements of the galvanometer motor for the rotation of the lens 240.

In an embodiment, the first limit wall 1131 and the second limit wall 1132 are planar, avoiding severe wear of the limit shaft 250.

In an embodiment, the limit shaft 250 is interference fitted or adhesively bonded to the second shaft 220. In an embodiment, the limit shaft 250 is pressed into the mounting hole of the second shaft 220 by radial pressure.

In an embodiment, the limit shaft 250 is a linear shaft, with the extension direction of the limit shaft 250 consistent with the radial direction of the second shaft 220. The first limit wall 1131 and the second limit wall 1132 also extend radially along the second shaft 220, increasing the contact area between the limit shaft 250 and the first limit wall 1131 and the second limit wall 1132.

Furthermore, the working conditions of LiDAR are complex, with the environmental temperature range generally being −40° C. to 120° C. The angular position sensor 400 may drift under such conditions, affecting the control accuracy of the galvanometer motor. In this application, the galvanometer motor can calibrate the angular position sensor 400 by mechanical impact between the limit shaft 250 and the first limit wall 1131 and the second limit wall 1132, improving control accuracy.

In an embodiment, during the startup of the galvanometer motor, mechanical calibration is performed using the hard limits between the limit shaft 250 and the first limit wall 1131 and the second limit wall 1132 to calibrate the angle signal. For example, at the initial moment, the limit shaft 250 is controlled to turn to the first limit wall 1131 and the second limit wall 1132 respectively, and the measurement values corresponding to the angular position sensor 400 are read out through the mechanical limit. Based on the measurement values, the angular position sensor 400 is calibrated to ensure that the readings of the limit shaft 250 at the mechanical limits of the first limit wall 1131 and the second limit wall 1132 are both half of the total mechanical travel. In other words, if the total mechanical travel is ±20°, after the impact, the angle calibration of the angular position sensor 400 can be set to −20° when the limit shaft 250 is at the first limit wall 1131, and the angle calibration of the angular position sensor 400 can be set to ±20° when the limit shaft 250 is at the second limit wall 1132. Then, when the limit shaft 250 is in the middle between the first limit wall 1131 and the second limit wall 1132, the angle calibration of the angular position sensor 400 is zero. At this time, the first limit wall 1131 and the second limit wall 1132 are symmetrically arranged about the limit shaft 250 on the left and right. Even considering wear, they remain symmetrical, ensuring the accuracy and reliability of the central zero point position.

Since high-precision angular position sensors 400 are expensive, large in size, and easily contaminated, ordinary angular position sensors 400 are generally used. However, ordinary angular position sensors 400 are prone to temperature drift. This application calibrates the angular position sensor 400 through the mechanical limit of the limit shaft 250, improving the control accuracy of the galvanometer motor and helping to control the cost and size of the galvanometer motor.

In an embodiment, the central angle formed between the first limit wall 1131 and the second limit wall 1132 is 5°, 10°, 20°, 30°, 45°, or 60°. When the galvanometer motor starts, the limit shaft 250 is located at the angle bisector of the central angle formed between the first limit wall 1131 and the second limit wall 1132.

In some embodiments, combined with FIGS. 4 and 5, the magnetic core 230 is a pair of radially magnetized poles. The stator winding 120 has only two wiring ends 124 connected to an alternating current, and only needs to input an alternating current in one direction as a control signal. The stator winding 120 generates an alternating magnetic field, driving the rotation of a pair of poles, including the entire rotor assembly 200 with the lens 240. The rotation of a pair of poles will cause the magnetic field signal they generate to change, facilitating the angular sensor to obtain the angular position of the rotor assembly 200 by sensing the magnetic field signal. Compared to multiple pairs of magnetic poles arranged in an alternating and encircling manner, the magnetic core 230 is a pair of radially magnetized poles, reducing the number of parts, compacting the structure, and facilitating the reduction of the installation difficulty of the galvanometer motor and the size of the galvanometer motor and LiDAR.

In some embodiments, the magnetic core 230 is cylindrical, with the outer diameter of the magnetic core 230 along the extension direction of the rotation axis X of the first shaft 210 remaining unchanged, ensuring that the driving force on the magnetic core 230 is uniform and unchanged in its length direction. The magnetic core 230 has a linear through-hole for sleeving the first shaft 210. The magnetic core 230 is magnetized by radial magnetization. In other words, the magnetic core 230 is divided into two halves by a plane passing through the rotation axis X of the first shaft 210, with the poles of the two halves of the magnetic core 230 being opposite. Among them, when the galvanometer motor is in the initial position, the part of the magnetic core 230 on one side of the limit shaft 250 and the part of the magnetic core 230 on the other side of the limit shaft 250 have opposite polarities.

In some embodiments, the magnetic core 230 is adhesively sleeved on the first shaft 210, simplifying the assembly and fixing process while reducing the use of auxiliary tools.

In some embodiments, the first shaft 210 has a first protruding ring 211, and the second shaft 220 has a second protruding ring 221, with the magnetic core 230 located between the first protruding ring 211 and the second protruding ring 221. One end of the magnetic core 230 abuts against the first protruding ring 211, and the other end of the magnetic core 230 abuts against the second protruding ring 221, achieving the positioning of the magnetic core 230 along the rotation axis X of the first shaft 210, ensuring the stability of the position of the magnetic core 230, and simplifying the assembly and positioning process.

In an embodiment, the end of the second shaft 220 is sleeved on the end of the first shaft 210. The end of the second shaft 220 is interference fitted with the end of the first shaft 210, simplifying the assembly process. In an embodiment, the end of the second shaft 220 can be adhesively bonded or welded to the end of the first shaft 210.

In an embodiment, combined with FIGS. 4 and 5, the first shaft 210 is fixedly connected to the lens 240 through a lens clamp 260. In an embodiment, the lens clamp 260 has a clamping groove 261, with the lens 240 mounted in the clamping groove 261. For example, the lens 240 is adhesively bonded in the clamping groove 261.

In an embodiment, the lens clamp 260 includes a first clamping part 262 and a second clamping part 263, with the first clamping part 262 and the second clamping part 263 closing together to clamp and fix on the end of the first shaft 210 extending out of the housing 110. For example, the first clamping part 262 and the second clamping part 263 each have a semi-cylindrical groove, with the semi-cylindrical grooves of the first clamping part 262 and the second clamping part 263 set opposite to each other, closing to form a cylindrical groove accommodating the first shaft 210, achieving the positioning and clamping of the first shaft 210.

In an embodiment, the first clamping part 262 and the second clamping part 263 are detachably connected. For example, the first clamping part 262 and the second clamping part 263 are connected by passing fasteners. The first clamping part 262 and the second clamping part 263 each have connection holes for the fasteners to pass through.

In an embodiment, the first clamping part 262 has the clamping groove 261.

In an embodiment, the magnetic core 230 and the first shaft 210 are assembled to form a first component, and the limit shaft 250 and the second shaft 220 are assembled to form a second component. The magnetic core 230 in the first component is radially magnetized, then the second shaft 220 of the second component is fixedly connected to the first shaft 210 of the first component, forming a third component. The magnetic mounting member 430 and the magnetic member 410 are sequentially assembled on the third component. After the third component is installed in the housing 110, the lens clamp 260 is installed on the end of the first shaft 210 extending out of the housing 110, and the lens 240 is assembled on the lens clamp 260.

In an embodiment, the first shaft 210, the second shaft 220, and the housing 110 are made of aluminum alloy material, and the limit shaft 250 can also be an aluminum alloy shaft. Aluminum alloy has good rigidity, and compared to metals such as steel and copper, it has the characteristic of low density, light weight, reducing the output density requirements of the galvanometer motor, and thus, by selecting a magnetic core 230 and stator winding 120 with a small magnetic field strength, it is possible to shorten the length of the magnetic core 230 and stator winding 120, reducing the size of the galvanometer motor and LiDAR.

In some embodiments, combined with FIGS. 2 and 3, the galvanometer motor also includes a first bearing 510 and a second bearing 520 alternately mounted inside the housing 110, with the first bearing 510 sleeved on the end of the first shaft 210 far away from the second shaft 220, and the second bearing 520 sleeved on the second shaft 220. The first bearing 510 and the second bearing 520 respectively support the first shaft 210 and the second shaft 220, allowing the rotor assembly 200 to be rotatably mounted inside the housing 110.

In an embodiment, the housing 110 has a bearing chamber 115, with the first bearing 510 placed in the bearing chamber 115, achieving the circumferential positioning of the first bearing 510, while the bottom wall of the bearing chamber 115 restricts the movement of the first bearing 510 along the rotation axis X of the first shaft 210 towards the lens 240.

In an embodiment, one end of the first bearing 510 abuts against the bottom wall of the bearing chamber 115, and the other end of the first bearing 510 abuts against the first protruding ring 211 of the first shaft 210, achieving the positioning of the first bearing 510 in the direction of the rotation axis X of the first shaft 210.

In an embodiment, combined with FIGS. 2 and 3, the galvanometer motor also includes an elastic member 530, which can be selected as a wave spring. One end of the elastic member 530 abuts against one end of the second bearing 520 far away from the first bearing 510, and the other end of the elastic member 530 abuts against the housing 110. The elastic member 530 provides a pre-tensioning force to the second bearing 520, eliminating the clearance of the second bearing 520.

In an embodiment, one end of the second bearing 520 abuts against the second protruding ring 221 of the second shaft 220, and the other end of the second bearing 520 abuts against the elastic member 530.

In an embodiment, the bore walls of the first bearing 510, the bore walls of the second bearing 520, the surface of the first shaft 210, and the surface of the second shaft 220 have a roughness of less than or equal to 0.1 micrometers, effectively reducing friction and vibration noise.

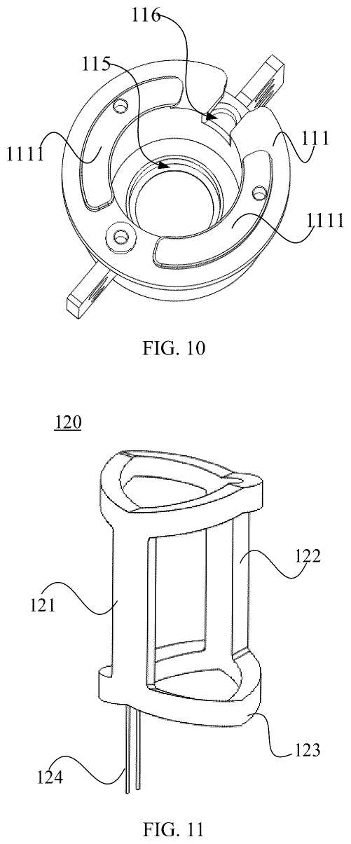

In some embodiments, combined with FIG. 3, FIG. 9, and FIG. 10, the housing 110 includes an outer cylinder 111 and an end cover 112. The outer cylinder 111 is used for mounting the stator winding 120, and the end cover 112 is connected to one end of the outer cylinder 111. In an embodiment, both ends of the outer cylinder 111 are open, with the end cover 112 mounted on one end of the outer cylinder 111. The opening allows the inner cavity of the end cover 112 and the inner cavity of the outer cylinder 111 to communicate and form a cavity for mounting the stator winding 120 and part of the rotor assembly 200.

In an embodiment, the stator winding 120 is adhesively bonded to the inner side wall of the housing 110, without the need for other auxiliary mounting structures, avoiding an increase in the diameter of the housing 110, and facilitating the miniaturization design of the galvanometer motor and LiDAR.

In an embodiment, the outer cylinder 111 and the end cover 112 are detachably connected. One end of the end cover 112 is sleeved on the end of the outer cylinder 111.

In an embodiment, the end of the outer cylinder 111 near the end cover 112 has an annular limit block 1111, with the inner wall of the annular limit block 1111 abutting against the circumferential wall of the second bearing 520, achieving the circumferential positioning of the second bearing 520. Optionally, the number of annular limit blocks 1111 is two. Additionally, the end of the outer cylinder 111 near the end cover 112 has a wire outlet groove 116.

In an embodiment, the end cover 112 has a support plate 1121, with the support plate 1121 perpendicular to the rotation axis X of the first shaft 210. The support plate 1121 has a through-hole for the second shaft 220 to pass through. One end of the second bearing 520 abuts against the end of the second protruding ring 221 far away from the magnetic core 230, and the other end of the second bearing 520 abuts against the support plate 1121. The second bearing 520 and the limit shaft 250 are located on both sides of the support plate 1121.

In some embodiments, combined with FIG. 11, the stator winding 120 is a single-phase winding, or a multi-phase winding. The stator winding 120 can be a copper wire winding, an aluminum wire winding, or a copper-clad aluminum wire winding. The stator winding 120 is wound to form a hollow winding, with no magnetic core inside the stator winding 120, which can reduce the rotational inertia and inductance of the galvanometer motor. It has the characteristics of small inductance and small back electromotive force, allowing the control signal to change more quickly and improving the response speed.

In an embodiment, combined with FIGS. 10 and 11, the stator winding 120 is a single-phase winding, with the single-phase winding including a first linear segment 121, a second linear segment 122, and a connecting segment 123. The connecting segment 123 connects the first linear segment 121 and the second linear segment 122, with the first linear segment 121 having a wiring end 124. The housing 110 has a wire outlet groove 116, with the length direction of the wire outlet groove 116 parallel to the rotation axis of the first shaft 210, and the wire outlet groove 116 and the first linear segment 121 located on the same radial direction of the first shaft 210, achieving precise positioning and mounting of the stator winding 120 on the housing 110.

In an embodiment, the wire outlet groove 116 communicates with the outside, with the wiring end 124 of the stator winding 120 electrically connected to the electronic control board 300 through the wire outlet groove 116.

In an embodiment, the connecting segment 123 is arc-shaped, extending circumferentially along the inner wall of the housing 110. The number of connecting segments 123 is four. The ends of the first linear segment 121 and the second linear segment 122 near the lens 240 are connected by two of the connecting segments 123, and the ends of the first linear segment 121 and the second linear segment 122 far away from the lens 240 are connected by the other two connecting segments 123.

In an embodiment, the length of the first linear segment 121 and the second linear segment 122 is 12 mm to 13 mm, which is as short as possible while meeting the driving force requirements of the magnetic core 230, facilitating the shortening of the length of the magnetic core 230 and the entire galvanometer motor.

In an embodiment, combined with FIG. 1, the outer wall of the end of the housing 110 near the lens 240 is provided with an avoidance chamfer 114, so that the outer diameter of the end of the housing 110 near the lens 240 gradually increases in a direction away from the lens 240.

When the galvanometer motor is used in LiDAR, the length of the galvanometer motor is too long, which is not conducive to installation within the LiDAR, and the end of the housing 110 near the lens 240 is prone to interference. The setting of the avoidance chamfer 114 can reduce the outer diameter of the end of the housing 110 near the lens 240, avoiding interference between the housing 110 and other components.

Embodiments of this application provides a LiDAR, which includes the galvanometer motor as described in any of the above items.

What is claimed is:

1. A galvanometer motor, comprising:
a stator assembly, the stator assembly comprising a housing and a stator winding, the stator winding being mounted inside the housing; and
a rotor assembly, the rotor assembly comprising a first shaft, a second shaft, a magnetic core, and a lens,
wherein the first shaft being rotatably disposed in the housing, an end of the first shaft extending out of the housing and being fixedly connected to the lens, another end of the first shaft being fixedly connected to the second shaft, the magnetic core being fixedly sleeved on the first shaft, the stator winding surrounding the magnetic core, and the stator winding generating an alternating magnetic field for driving the magnetic core to rotate.

2. The galvanometer motor according to claim 1, further comprising an electronic control board and an angular position sensor, the electronic control board being mounted in the housing, the angular position sensor being configured to detect an angular position of the rotor assembly, and the angular position sensor being electrically connected to the electronic control board.

3. The galvanometer motor according to claim 2, wherein the electronic control board is mounted in the housing at an end far away from the lens, the angular position sensor comprises a magnetic member and a magnetic encoder, the magnetic member is mounted on the second shaft, the magnetic encoder is mounted on the electronic control board, and there is a gap between the magnetic encoder and the magnetic member.

4. The galvanometer motor according to claim 3, wherein the magnetic member is mounted on an end of the second shaft close to the electronic control board, the magnetic encoder is mounted on a surface of the electronic control board close to the second shaft, the gap is greater than or equal to 1.2 mm, and the gap is less than or equal to 3 mm.

5. The galvanometer motor according to claim 3, wherein the angular position sensor further comprises a magnetic mounting member, one end of the magnetic mounting member has a first mounting groove for fixedly sleeving the second shaft, and another end of the magnetic mounting member has a second mounting groove for fixedly sleeving the magnetic member.

6. The galvanometer motor according to claim 1, wherein the housing has a limit groove, the limit groove has a first limit wall and a second limit wall that are alternately distributed along a rotation direction of the rotor assembly, the rotor assembly further comprises a limit shaft, one end of the limit shaft is mounted on the second shaft, another end of the limit shaft is located in the limit groove, and the limit shaft swings between the first limit wall and the second limit wall with the second shaft.

7. The galvanometer motor according to claim 1, wherein the stator winding is a single-phase winding, the single-phase winding comprises a first linear segment, a second linear segment, and a connecting segment, the connecting segment connects the first linear segment and the second linear segment, the first linear segment has a wiring end, the housing has a wire outlet groove, a length direction of the wire outlet groove is parallel to an axis of rotation of the first shaft, and the wire outlet groove and the first linear segment are on the same radial direction of the first shaft.

8. The galvanometer motor according to claim 1, wherein the outer wall of the end of the housing close to the lens is provided with an avoidance chamfer, so that the outer diameter of the end of the housing close to the lens gradually increases in a direction far away from the lens.

9. The galvanometer motor according to claim 1, further comprising a first bearing and a second bearing alternately mounted in the housing, wherein the first bearing is sleeved on an end of the first shaft far away from the second shaft, the second bearing is sleeved on the second shaft,
wherein the galvanometer motor further comprises an elastic member, one end of the elastic member abuts an end of the second bearing far away from the first bearing, and another end of the elastic member abuts the housing,
wherein the housing comprises an outer cylinder and an end cover, the outer cylinder is used for mounting the stator winding, and the end cover is connected to the outer cylinder at an end far away from the lens.
